(19) United States
(12) Patent Application Publication
(10) Pub. No.: US 2014/0265704 A1
(43) Pub. Date: Sep. 18, 2014

(54) ROTOR INCLUDING PERMANENT MAGNETS HAVING DIFFERENT THICKNESSES AND MOTOR INCLUDING SAME

(71) Applicant: KOREA ELECTRONICS TECHNOLOGY INSTITUTE, Seongnam-si, Gyeonggi-do (KR)

(72) Inventors: Sehyun Rhyu, Bucheon-si (KR); Jungmoo Seo, Seoul (KR); Youngkyoun Kim, Seoul (KR); Jeongjong Lee, Incheon (KR); Insoung Jung, Seoul (KR)

(21) Appl. No.: 14/353,422

(22) PCT Filed: Nov. 2, 2012
(86) PCT No.: PCT/KR2012/010369

§ 371 Date: Apr. 22, 2014

(30) Foreign Application Priority Data
Dec. 5, 2011 (KR) 10-2011-0128927
Dec. 5, 2011 (KR) 10-2011-0128928
Dec. 5, 2011 (KR) 10-2011-0128929

(51) Int. Cl. H02K 1/27

(52) U.S. Cl. CPC H02K 1/2706
USPC 310/156.38

(57) ABSTRACT

The present invention relates to a rotor including permanent magnets having different thicknesses and to a motor including the same. In the rotor, the permanent magnets having different thicknesses at both ends thereof are inserted into the iron core of the rotor to solve the imbalance of gap flux density. According to the present invention, the motor includes a rotor and a stator having a rotor insertion hole in which the rotor is inserted in the center thereof, wherein a coil is wound around the inner circumferential surface of the rotor insertion hole. Here, the rotor includes a rotor iron core and a plurality of permanent magnets. The rotor iron core has a rotating shaft insertion hole in which a rotating shaft is inserted in the center thereof, and a plurality of permanent magnet insertion holes are defined in the circumference of the rotating shaft insertion hole.

### CROSS-REFERENCE TO RELATED APPLICATION

This application claims priority to and the benefit of Korean Patent Application No. 10-2011-0128927, 10-2011-0128928 and 10-2011-0128929 filed in the Korean Intellectual Property Office on Dec. 5, 2011 respectively, the entire contents of which are incorporated herein by reference.

### TECHNICAL FIELD

The present invention relates to a motor, and more particularly, to a rotor including permanent magnets having different thicknesses, in which the permanent magnets having different thicknesses at both ends thereof are inserted into an iron core of the rotor so that gap flux density may be formed in a sine curve shape, and a motor including the same.

### BACKGROUND

Typically, a motor is a device which converts electric energy into mechanical energy and generates a rotational force, and widely used in the home and for industry. The motor may be classified into an AC motor and a DC motor.

The DC motor is driven with DC power, and obtains a desired output by changing an input voltage. Since speed control of the DC motor is relatively easy, the DC motor is used for driving a streetcar, an elevator or the like. The DC motor may be classified into a brush DC motor and a brushless DC motor. When compared to the brush DC motor, the brushless DC motor has a property of not having a brush and a commutator as mechanical contact portions. Therefore, the brushless DC motor may have high performance, a light, thin and small size and a long life span. Further, the brushless DC motor has a structure in which a coil is wound on a stator, and a permanent magnet is embedded in a rotor. The brushless DC motor is widely used in various apparatuses according to development of semiconductor technology and components or materials.

The AC motor driven with AC power is a kind of motor which is the most widely used in the surroundings of life. The AC motor basically includes an external stator and an internal rotor. When an AC current is supplied to a coil of the stator, an electric field thereof is changed by electromagnetic induction, and an induced current is generated by a rotating electric field around the rotor, and a rotational force is generated at a rotational shaft disposed in the rotor by a torque.

The AC motor may be generally classified into a single-phase type AC motor and a three-phase type AC motor, and also may be classified into an induction motor, a synchronous motor and a commutator motor according to the type of the rotor.

A synchronous motor such as a line start permanent magnet (LSPM) motor (or referred to as ‘a single-phase induction synchronous motor) is a kind of AC motor to which only advantages of the single induction motor and the synchronous motor are applied. The synchronous motor as described above is a motor in which the rotor is rotated and driven by a torque generated by an interaction between a secondary current generated by a voltage deserted to a conductive bar of the rotor and a magnetic flux generated by the coil of the stator, and when the rotor is operated with a normal speed, a magnetic flux of a permanent magnet installed at the rotor and a magnetic flux generated from the stator are mutually synchronized, and thus which is operated at a speed of a rotating magnetic field of the stator. That is, when a current is applied to the coil of the stator, the rotor is rotated by an interaction between a rotating magnetic flux generated due to a structure of the stator and an induction current generated at the conductive bar. When the rotor arrives at a synchronous speed, the rotor is rotated by a torque generated by the permanent magnet and a reluctance torque generated due to a structure of the rotor.

The rotor of the LSPM motor includes a cylindrical rotor iron core, a plurality of conductive bars inserted around the edge of the rotor iron core, and a plurality of permanent magnets inserted at the inside of the conductive bars.

Since the high performance permanent magnets is applied to the LSPM motor having the above-mentioned structure, the LSPM motor may have a large output, but also have a problem in that vibration and noise are increased due to a cogging torque. The cogging torque is closely connected with gap flux density. In a conventional LSPM motor, since the gap flux density is formed in a square wave shape, the vibration and the noise are generated seriously.

That is, in the case in which an N pole and an S pole are formed by the plurality of permanent magnets installed at the rotor iron core, the permanent magnets having the same sizes are inserted and installed at symmetrical positions with respect to a rotational shaft of the rotor. Therefore, an attractive force and a repulsive force are generated at the N pole and the S pole due to a magnetomotive force generated by the plurality of permanent magnets and the coil of the stator, and thus the rotational force is generated continuously.

However, since the attractive force is additionally generated in a rotational direction of the rotor, at the N pole, the additionally generated attractive force is added and thus the gap flux density is increased, but at the S pole, an intensity of the magnetic flux is offset by the additionally generated attractive force and thus the gap flux density is reduced. Therefore, the gap flux density of the rotor is unbalanced, and thus problems such as reduction in the output and increase in a torque ripple are encountered.

### SUMMARY

The present invention is directed to providing a rotor including permanent magnets having different thicknesses, which reduces a cogging torque and thus has excellent noise characteristic, and a motor including the same.

The present invention is also directed to providing a rotor including permanent magnets having different thicknesses, in which gap flux density is formed in a sine curve shape so as to reduce the cogging torque and minimize the torque ripple, thereby improving vibration and noise characteristics, and a motor including the same.

One aspect of the present invention provides a rotor of a motor, which includes permanent magnets having different thicknesses and is rotatably inserted and installed into a rotor insertion hole of a stator, including a rotor iron core configured to have a rotational shaft insertion hole, in which a rotational shaft is inserted, at a center thereof, and also have a plurality of permanent magnet insertion holes around the rotational shaft insertion hole, and a plurality of permanent magnets inserted into the plurality of permanent magnet insertion holes to form an N pole and an S pole, wherein the plurality of permanent magnets have different thicknesses according to distances from centers of the magnetic poles, and thick portions of the plurality of permanent magnets are disposed at the center of the magnetic pole and thin portions thereof are disposed at an edge of the magnetic pole.

The plurality of permanent magnets may be installed to be symmetrical centering on the rotational shaft insertion hole, a section in a vertical direction with respect to the rotational shaft has a trapezoidal shape, and sides thereof facing the rotational shaft insertion hole are longer in length than other sides thereof adjacent to the sides facing the rotational shaft insertion hole.

Each of the plurality of permanent magnets may include a first side facing the rotational shaft insertion hole, a second side facing the first side, a third side configured to connect one ends of the first and second sides and to be shorter than the first and second sides and to be disposed at a center portion of the magnetic pole, and a fourth side configured to connect the other ends of the first and second sides and to be shorter than the third side and to be disposed at an edge portion of the magnetic pole.

The plurality of permanent magnets may include one pair of first permanent magnets configured to form the N pole and to be adjacent to each other; and one pair of second permanent magnets configured to form the S pole and to be adjacent to each other, and the thick portions of the one pair of first permanent magnets may be disposed to face each other, and the thin portions thereof are disposed at opposite sides thereto, and the thick portions of the one pair of second permanent magnets may be disposed to face each other, and the thin portions thereof are disposed at opposite sides thereto.

An angle between the one pair of first permanent magnets and an angle between the one pair of second permanent magnets may be obtuse angles, and an angle between one of the first permanent angles and one of the second permanent angles, which are adjacent to each other, may be an acute angle.

The rotor iron core may have a plurality of conductive bar insertion holes formed around outer sides of the plurality of permanent magnet insertion holes, and the rotor may further include a plurality of conductive bars inserted and installed in the plurality of conductive bar insertion holes.

Gaps among the plurality of conductive bars may be constant.

The plurality of permanent magnets may be disposed so that a gap between the conductive bars disposed at the center of the magnetic pole formed by the plurality of permanent magnets is formed to be wider than a gap between the conductive bars disposed at the edge of the magnetic pole.

The gaps among the plurality of conductive bars may be formed to be gradually reduced from the center of the magnetic pole toward the edge thereof.

A gap between the conductive bar insertion holes disposed at the center of the magnetic pole formed by the plurality of permanent magnets may be formed to be wider than a gap between the conductive bar insertion holes disposed at the edge of the magnetic pole.

A gap between the conductive bar insertion holes disposed at the center of the magnetic pole formed by the plurality of permanent magnets may be formed to be wider than a gap between the conductive bar insertion holes disposed at the edge of the magnetic pole.

The plurality of permanent magnets may be disposed so that lengths of the conductive bars disposed at the center of the magnetic pole formed by the plurality of permanent magnets are formed to be shorter than lengths of the conductive bars disposed at the edge of the magnetic pole.

Another aspect of the present invention provides a motor which includes permanent magnets having different thicknesses, including the above-mentioned rotor, and a stator configured to have a rotor insertion hole, in which the rotor is inserted, at a center thereof and to include a coil wound around an inner circumferential surface of the rotor insertion hole.

According to the present invention, when the permanent magnets are inserted into the rotor iron core, the thick portions of the permanent magnets are disposed at the center of the magnetic pole, and the thin portions thereof are disposed at the edge of the magnetic pole, and thus the gap flux density may be formed in the sine curve shape, and the torque ripple may be minimized, and the vibration and noise characteristics may be improved.

That is, when the plurality of permanent magnets are disposed at the rotor iron core, the thick portions of the permanent magnets are disposed at the center of the magnetic pole, and the thin portions thereof are disposed at the edge of the magnetic pole, and thus a higher magnetic flux may be generated at the center of the magnetic pole than the edge thereof. Therefore, the gap flux density is formed in the sine curve shape, and the cogging torque and the torque ripple may be reduced. In this instance, the generation of vibration and noise may be minimized when the motor is driven.

Further, the gap between the conductive bars disposed at the center of the magnetic pole formed by the plurality of permanent magnets is formed to be wider than the gap the conductive bars disposed at the edge of the magnetic pole, such that the gap flux density is focused on the center of the magnetic pole, and thus formed in the sine curve shape. Since the gap flux density is formed in the sine curve shape, the cogging torque generated when the synchronous motor is driven may be reduced, and the generation of vibration and noise may be also minimized when the synchronous motor is driven.

Also, the lengths of the conductive bars disposed at the center of the magnetic pole formed by the plurality of permanent magnets is formed to be shorter than the lengths of the conductive bars disposed at the edge of the magnetic pole, such that the gap flux density is focused on the center of the magnetic pole, and thus formed in the sine curve shape. Since the gap flux density is formed in the sine curve shape, the cogging torque generated when the synchronous motor is driven may be reduced, and the generation of vibration and noise may be also minimized when the synchronous motor is driven.

In addition, the gap between the conductive bars disposed at the center of the magnetic pole formed by the plurality of permanent magnets is formed to be wider than the gap the conductive bars disposed at the edge of the magnetic pole, such that the gap flux density is focused on the center of the magnetic pole, and thus formed to be closer to the sine curve shape.

### BRIEF DESCRIPTION OF DRAWINGS

FIG. 1 is a plan view illustrating a rotor of a motor according to a first embodiment of the present invention.

FIG. 2 is a plan view illustrating a rotor of a motor according to a second embodiment of the present invention.

FIG. 3 is a plane view illustrating of a motor having the rotor of FIG. 2.

FIG. 4 is a view schematically illustrating gap flux density generated by a structure of the rotor of FIG. 3 and a wave pattern diagram thereof.

FIG. 5 is a plan view illustrating a rotor of a synchronous motor including permanent magnets having different thicknesses and conductive bars having different gaps according to a third embodiment of the present invention.

FIG. 6 is a plan view illustrating a synchronous motor having the rotor of FIG. 5.

FIG. 7 is a view schematically illustrating gap flux density generated by a structure of the rotor of FIG. 5 and a wave pattern diagram thereof.

FIG. 8 is a plan view illustrating a rotor of a synchronous motor including permanent magnets having different thicknesses and conductive bars having different lengths according to a fourth embodiment of the present invention.

FIG. 9 is a plan view a synchronous motor having the rotor of FIG. 8.

FIG. 10 is a view schematically illustrating gap flux density generated by a structure of the rotor of FIG. 8 and a wave pattern diagram thereof.

FIG. 11 is a plan view illustrating a rotor of a synchronous motor including permanent magnets having different thicknesses and conductive bars having different lengths according to a fifth embodiment of the present invention.

### DETAILED DESCRIPTION

In the following description, detailed descriptions of well-known functions or constructions will be omitted since they would obscure the invention in unnecessary detail.

It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

Hereinafter, exemplary embodiments of the present invention will be described in detail.

FIG. 1 is a plan view illustrating a rotor 20 of a motor according to a first embodiment of the present invention.

Referring to FIG. 1, the rotor 20 is a rotor of a motor, which is inserted into a rotor insertion hole of a stator and installed to be rotatable, and includes a rotor iron core 21 and a plurality of permanent magnets 22 embedded in the rotor iron core 21. The rotor iron core 21 has a rotational shaft insertion hole 25 at a center thereof, in which a rotational shaft 30 is inserted, and a plurality of permanent magnet insertion holes 26 around the rotational shaft insertion hole 25. The plurality of permanent magnets 22 are respectively inserted into the permanent magnet insertion holes 26 to form an N pole and an S pole. At this time, the plurality of permanent magnets 22 have different thicknesses according to a distance from a center of the magnetic pole, and thick portions b thereof are disposed to the center side of the magnetic pole, and thin portions a thereof are disposed to the edge side of the magnetic pole.

In the rotor 20 according to the first embodiment as described above, when the permanent magnets 22 are inserted into the rotor iron core 21, the permanent magnets 22 are inserted and installed so that the thick portions b thereof are disposed at the center side of the magnetic pole, and the thin portions a thereof are disposed at the edge side of the magnetic pole. Therefore, gap flux density is formed in a sine curve shape, thereby reducing a cogging torque, minimizing a torque ripple and thus improving vibration and noise characteristics.

That is, when the permanent magnets 22 are disposed at the rotor iron core 21, the thick portions thereof are disposed at the center side of the magnetic pole, and the thin portions thereof are disposed at the edge side of the magnetic pole (a<b), and thus a higher magnetic flux may be generated at the center of the magnetic pole relative to the edge thereof. Therefore, the gap flux density of the motor having the rotor 20 according to the first embodiment is formed in the sine curve shape, and the cogging torque and the torque ripple of the motor may be reduced. In this instance, generation of vibration and noise may be minimized when the motor is driven.

Specifically, the rotor 20 according to the first embodiment will be described.

The rotor iron core 21 is formed by axially stacking a plurality of rotor iron plates 24 having the same shapes. The rotational shaft insertion hole 25 in which the rotational shaft 30 is inserted is formed in the center of the rotor iron core 21. The plurality of permanent magnet insertion holes 26 are formed in the rotor iron core 21 around the rotational shaft insertion hole 25.

At this time, silicon steel plates may be used for the rotor iron plates 24. The rotational shaft insertion hole 25 and the permanent magnet insertion holes 26 may be formed to be vertical with respect to an upper surface of the rotor iron core 21.

The first embodiment illustrates a case in which four permanent magnet insertion holes 26 in which the permanent magnets 22 are installed so as to have a quadrangular shape in section with respect to an axial direction of the rotational shaft insertion holes 25 around the rotational shaft insertion hole 25 are formed in the rotor iron core 21, but is not limited thereto. For example, the permanent magnet insertion holes 26 may have a trapezoidal shape in section with respect to the axial direction of the rotational shaft insertion holes 25.

And the plurality of permanent magnets 22 are inserted and installed in the plurality of permanent magnet insertion holes 26 of the rotor iron core 21. At this time, the plurality of permanent magnets 22 generate a torque by an interaction with a magnetic flux generated from a coil. Rare earth magnets may be used for the permanent magnets 22.

Particularly, in order to solve imbalance of the gap flux density, the plurality of permanent magnets 22 are inserted and installed in the permanent magnet insertion holes 26 so that the thick portions b thereof are disposed at the center side of the magnetic pole, and the thin portions a thereof are disposed at the edge side of the magnetic pole. The reason why the plurality of permanent magnets 22 are disposed as described above is to form the higher magnetic flux at the center side of the magnetic pole than the edge side thereof and thus to form the gap flux density in the sine curve shape. By forming the gap flux density in the sine curve shape, the cogging torque and the torque ripper of the motor may be reduced, and thus the generation of the vibration and noise may be minimized when the motor is driven.

At this time, the plurality of permanent magnets 22 may be installed to be symmetrical with respect to the rotational shaft insertion hole 25, and may have the trapezoidal shape in section in a vertical direction of the rotational shaft 30. The plurality of permanent magnets 22 have longer lengths at the sides thereof facing the rotational shaft insertion hole 25 relative to the other sides. That is, the plurality of permanent magnets 22 may respectively have a first side 41, a second side 42, a third side 43 and a fourth side 44. At this time, the first side 41 is opposite to the rotational shaft insertion hole 25. The second side 42 is opposite to the first side 41. The third side 43 connects one ends of the first and second sides 41 and 42, and is shorter than the first and second sides 41 and 42 and is disposed at the center of the magnetic pole. And the fourth side 44 connects the other ends of the first and second sides 41 and 42, and is shorter than the third side 43, and is disposed at the edge of the magnetic pole. At this time, the third and fourth sides 43 and 33 of the plurality of permanent magnets 22 may have a parallel trapezoidal shape.

For example, the plurality of permanent magnets 22 may include a pair of first permanent magnets 28 configured to form the N pole and to be adjacent to each other, and a pair of second permanent magnets 29 configured to form the S pole and to be adjacent to each other. The pair of first permanent magnets 28 and the pair of second permanent magnets 29 are installed at the rotor iron core 21 to be symmetrical with respect to the rotational shaft 30. Of course, the thick portions b of the pair of first permanent magnets 28 are disposed to face each other, and the thin portions a thereof are disposed at an opposite side thereto. The thick portions b of the pair of second permanent magnets 29 are also disposed to face each other, and the thin portions a thereof are disposed at an opposite side thereto. At this time, each angle between the pair of first permanent magnets 28 and between the pair of second permanent magnets 29 may be an obtuse angle, and each angle between the adjacent first and second permanent magnets 28 and 29 may be an acute angle. That is, the angle formed between the pair of first permanent magnets 28 and the angle formed between the pair of second permanent magnets 29 are the obtuse angles, and the angle formed between one of the first permanent magnets 28 and one of the pair of second permanent magnets 29, which are adjacent to each other, is the acute angle.

As illustrated in FIG. 1, two first permanent magnets 28 and two second permanent magnets 29 may be provided. The plurality of first and second permanent magnets 28 and 29 may be inserted and installed in the rotor iron core 21 so that the angle between the pair of first permanent magnets 28 and the angle between the pair of second permanent magnets 29 may be 90 degrees or more, respectively, and the angle between the adjacent first and second permanent magnets 28 and 29 may be 90 degrees or less.

The first embodiment illustrates a case in which the four permanent magnets 22 are disposed around the rotational shaft insertion hole 25, and the pair of first permanent magnets 28 form the N pole, and the pair of second permanent magnets 29 form the S pole, but is not limited thereto. For example, four or more even-numbered permanent magnets 22 may be inserted and installed in the rotor iron core 21, or the plurality of adjacent permanent magnets 22 may be inserted and installed in the rotor iron core 21 to have different magnetic poles.

Meanwhile, the first embodiment illustrates that the third and fourth sides 43 and 44 of each of the permanent magnets have the parallel trapezoidal shape, but is not limited thereto. For example, the third and fourth sides 43 and 44 may not be parallel with each other. Of course, the third side 43 is formed to be thicker than the fourth side 44 (a<b).

As described above, the rotor 20 according to the first embodiment of may be used for a rotor of a brushless DC motor.

FIG. 2 is a plan view illustrating a rotor 120 of a motor according to a second embodiment of the present invention.

Referring to FIG. 2, the rotor 120 according to the second embodiment includes a rotor iron core 21, a plurality of permanent magnets 22 and a plurality of conductive bars 23. Here, since a structure in which the plurality of permanent magnets 22 are inserted and installed in the rotor iron core 21 is the same as that in the rotor 20 (FIG. 1) according to the first embodiment, the detailed description thereof will be omitted, and the plurality of conductive bars 23 will be centrally described.

The rotor iron core 21 has a plurality of conductive bar insertion holes 27 around outer sides of a plurality of permanent magnet insertion holes 26. Here, the plurality of conductive bar insertion holes 27 may be formed in the same direction as the plurality of permanent magnet insertion holes 26 so as to pass through the rotor iron core 21. The plurality of conductive bar insertion holes 27 have elongated shapes to be disposed at an edge of the rotor iron core 21. The conductive bar insertion holes 27 may be formed in slot shapes toward the permanent magnets 22. For example, the conductive bar insertion holes 27 may have an elongated ellipse shape or an elongated quadrangular shape of which each long side has both ends formed to be convex toward an outer side thereof. The plurality of conductive bar insertion holes 27 may be formed in the same shapes. The plurality of conductive bar insertion holes 27 may be spaced apart from each other at regular intervals (d1=d2).

The plurality of conductive bars 23 are inserted and installed in the plurality of conductive bar insertion holes 27. The plurality of conductive bars 23 may be formed to be spaced apart from each other at regular intervals. The plurality of conductive bars 23 may be installed in the plurality of conductive bar insertion holes 27 in a die-casting manner. At this time, the conductive bars 23 may be generally formed of an aluminum material (Al) having excellent electrical conductivity and die-casting performance. The conductive bars 23 formed in the die-casting manner are formed to have shapes corresponding to shapes of the conductive bar insertion holes 27.

Since the rotor 120 according to the second embodiment has the same arrangement structure of the permanent magnets 22 as that in the rotor 20 (FIG. 1) according to the first embodiment, when the plurality of permanent magnets 22 are inserted into the rotor iron core 21, the thick portions b thereof are disposed at the center of the magnetic pole, and the thin portions a thereof are disposed at the edge of the magnetic pole, like in the rotor 20 (FIG. 1) according to the first embodiment, such that the gap flux density may be formed in the sine curve shape, and the cogging torque and the torque ripple may be reduced and minimized, and thus the vibration and noise characteristics may be improved.

A motor 100 having the rotor 120 according to the second embodiment, as described above, will be described with reference to FIG. 3. Here, FIG. 3 is a plane view illustrating of a motor 100 having the rotor 120 of FIG. 2.

The motor 100 having the rotor 120 according to the second embodiment is a synchronous motor such as a line start permanent magnet (LSPM) motor, and includes the rotor 120 and a stator 10 in which the rotor 120 is rotatably inserted and installed. The stator 10 has a rotor insertion hole 18 at a center thereof, and a coil 16 is wound around an inner circumferential surface of the rotor insertion hole 18. And the rotor 120 is rotatably inserted and installed in the rotor insertion hole 18 of the stator 10.

Here, the stator 10 includes a stator iron core 11 provided with the rotor insertion hole 18, and the coil 16 wound along the inner circumferential surface of the rotor insertion hole 18 of the stator iron core 11. At this time, an inner diameter of the rotor insertion hole 18 is formed to be larger than an outer diameter of the rotor 120, and a gap is defined by a difference between the inner diameter of the rotor insertion hole 18 and the outer diameter of the rotor 120.

The stator iron core 11 is formed by axially stacking a plurality of stator iron plates 12 having the same shapes. The stator iron core 11 has the rotor insertion hole 18 in which the rotor 120 may be inserted and located. The stator iron core 11 has a plurality of teeth 14 formed along an inner circumferential surface thereof to be spaced apart at regular intervals. The plurality of teeth 14 protrude from the inner circumferential surface of the stator iron core 11 toward a central axis of the stator iron core 11 to be close to an outer circumferential surface of the rotor 120 which is inserted and installed in the rotor insertion hole 18. At this time, silicon steel plates may be used for the stator iron plates 12. An inside of a virtual surface formed by distal ends of the teeth 14 of the stator iron core 11 forms the rotor insertion hole 18.

And the coil 16 is wound on each of the plurality of teeth 14, and when an AC power source is applied thereto, a rotational magnetic flux is generated by a structure of the stator 10.

Meanwhile, although not shown, a rotational shaft 30 is rotatably installed via a bearing at a casing or a shell forming a case of the motor 100.

In the motor 100 as described above, the rotor 120 is started to be rotated and driven by a torque generated due to an interaction between a secondary current generated by a voltage deserted to the conductive bars 23 of the rotor 120 and a magnetic flux generated by the coil 16 of the stator 10, and when the rotor 120 is operated with a normal speed, the magnetic flux of the permanent magnets 22 installed at the rotor 120 and the magnetic flux generated from the stator 10 are mutually synchronized, and thus the rotor 120 is operated at a speed of a rotating magnetic field of the stator 10.

At this time, when the plurality of permanent magnets 22 are inserted and installed in the rotor iron core 21, the thick portions b thereof are disposed to the center side of the magnetic pole, and the thin portions a thereof are disposed to the edge side of the magnetic pole. Therefore, the gap flux density is formed in the sine curve shape, thereby reducing a cogging torque, minimizing a torque ripple and thus improving vibration and noise characteristics.

That is, when the permanent magnets 22 are inserted and installed in the rotor iron core 21, the thick portions thereof are disposed to the center side of the magnetic pole, and the thin portions thereof are disposed to the edge side of the magnetic pole, and thus, as illustrated in a wave pattern diagram of FIG. 4, a higher magnetic flux may be generated at the center of the magnetic pole relative to the edge thereof. Therefore, the gap flux density may be formed in the sine curve shape. At this time, in the wave pattern diagram of FIG. 4, a horizontal axis indicates an angle θ, and a vertical indicates magnetic flux density B.

FIG. 5 is a plan view illustrating a rotor 20a of a synchronous motor including permanent magnets 22 having different thicknesses and conductive bars 23 having different gaps according to a third embodiment of the present invention. FIG. 6 is a plan view illustrating a synchronous motor 100a having the rotor 20a of FIG. 5. And FIG. 7 is a view schematically illustrating the gap flux density generated by a structure of the rotor 20a of FIG. 5 and a wave pattern diagram thereof.

Referring to FIGS. 5 to 7, the synchronous motor 100a according to the third embodiment of the present invention includes the rotor 20a and a stator 10 in which the rotor 20a is rotatably inserted and installed. The stator 10 has a rotor insertion hole 18 at a center thereof, and a coil 16 is wound around an inner circumferential surface of the rotor insertion hole 18. The rotor 20a is inserted into the rotor insertion hole 18 of the stator 10 and installed to be rotatable.

The stator 10 includes a stator iron core 11 having the rotor insertion hole 18, and the coil 16 wound along the inner circumferential surface of the rotor insertion hole 18 of the stator iron core 11. At this time, an inner diameter of the rotor insertion hole 18 is formed to be larger than an outer diameter of the rotor 20a, and a gap is defined by a difference between the inner diameter of the rotor insertion hole 18 and the outer diameter of the rotor 20a.

The stator iron core 11 is formed by axially stacking a plurality of stator iron plates 12 having the same shapes. The stator iron core 11 has the rotor insertion hole 18 in which the rotor 20a may be inserted and located. The stator iron core 11 has a plurality of teeth 14 formed along an inner circumferential surface thereof to be spaced apart at regular intervals. The plurality of teeth 14 protrude from the inner circumferential surface of the stator iron core 11 toward a central axis of the stator iron core 11 to be close to an outer circumferential surface of the rotor 20a which is inserted and installed in the rotor insertion hole 18. At this time, silicon steel plates may be used for the stator iron plates 12. An inside of a virtual surface formed by distal ends of the teeth 14 of the stator iron core 11 forms the rotor insertion hole 18.

And the coil 16 is wound on each of the plurality of teeth 14, and when an AC power source is applied thereto, a rotational magnetic flux is generated by a structure of the stator 10.

Meanwhile, although not shown, a rotational shaft 30 is rotatably installed via a bearing at a casing or a shell forming a case of the motor 100a.

The rotor 20a is a rotor of the synchronous motor 100a which is inserted into the rotor insertion hole and installed to be rotatable, and includes a rotor iron core 21, and a plurality of permanent magnets 22 and a plurality of conductive bars 23 embedded in the rotor iron core 21. The rotor iron core 21 has a rotational shaft insertion hole 25 at a center thereof, in which a rotational shaft 30 is inserted and installed, and a plurality of permanent magnet insertion holes 26 around the rotational shaft insertion hole 25, and a plurality of conductive bar insertion holes 27 around an outside of the plurality of permanent magnet insertion holes 26. The plurality of permanent magnets 22 are respectively inserted into the permanent magnet insertion holes 26 to form an N pole and an S pole. The plurality of conductive bars 23 are respectively inserted and installed into the plurality of conductive bar insertion holes 27. At this time, the plurality of permanent magnets 22 have different thicknesses according to a distance from a center of the magnetic pole, and thick portions b thereof are disposed to the center side of the magnetic pole, and thin portions a thereof are disposed to the edge side of the magnetic pole. A gap d1 between the conductive bars 23 located at the center of the magnetic pole formed by the plurality of permanent magnets 22 is formed to be wider than a gap d2 between the conductive bars 23 at the edge of the magnetic pole.

As described above, in the rotor 20a according to the third embodiment, when the permanent magnets 22 are inserted into the rotor iron core 21, the permanent magnets 22 are inserted and installed so that the thick portions b thereof are disposed at the center side of the magnetic pole, and the thin portions a thereof are disposed at the edge side of the magnetic pole. Therefore, gap flux density is formed in a sine curve shape, thereby reducing a cogging torque, minimizing a torque ripple and thus improving vibration and noise characteristics.

That is, when the permanent magnets 22 are disposed at the rotor iron core 21, the thick portions thereof are disposed at the center side of the magnetic pole, and the thin portions thereof are disposed at the edge side of the magnetic pole (a<b), and thus a higher magnetic flux may be generated at the center of the magnetic pole than the edge thereof. Therefore, the gap flux density of the motor having the rotor 20a according to the third embodiment is formed in the sine curve shape, and the cogging torque and the torque ripple of the motor may be reduced. In this instance, generation of vibration and noise may be minimized when the motor is driven.

Further, a gap d1 between the conductive bars 23 located at the center of the magnetic pole formed by the permanent magnets 22 is formed to be wider than a gap d2 between the conductive bars 23 at the edge of the magnetic pole, such that the gap flux density is focused on the center of the magnetic pole, and thus formed in the sine curve shape. Since the gap flux density is formed in the sine curve shape, the cogging torque generated when the synchronous motor 100a is driven may be reduced, and the generation of vibration and noise may be also minimized when the synchronous motor 100a is driven.

Specifically, the rotor 20a according to the third embodiment will be described.

The rotor iron core 21 is formed by axially stacking a plurality of rotor iron plates 24 having the same shapes. The rotational shaft insertion hole 25 in which the rotational shaft 30 is inserted is formed in the center of the rotor iron core 21. The plurality of permanent magnet insertion holes 26 are formed in the rotor iron core 21 around the rotational shaft insertion hole 25. And the rotor iron core 21 has the plurality of conductive bar insertion holes 27 formed around the outside of the plurality of permanent magnet insertion holes 26.

At this time, silicon steel plates may be used for the rotor iron plates 24. The rotational shaft insertion hole 25 and the permanent magnet insertion holes 26 may be formed to be vertical with respect to an upper surface of the rotor iron core 21.

The third embodiment illustrates an example in which four permanent magnet insertion holes 26 in which the permanent magnets 22 are installed so as to have a quadrangular shape in section with respect to an axial direction of the rotational shaft insertion holes 25 around the rotational shaft insertion hole 25 are formed in the rotor iron core 21, but is not limited thereto. For example, the permanent magnet insertion holes 26 may have a trapezoidal shape in section with respect to the axial direction of the rotational shaft insertion holes 25.

And the plurality of permanent magnets 22 are inserted and installed in the plurality of permanent magnet insertion holes 26 of the rotor iron core 21. At this time, the plurality of permanent magnets 22 generate a torque by an interaction with a magnetic flux generated from a coil. Rare earth magnets may be used for the permanent magnets 22.

Particularly, in order to solve imbalance of the gap flux density, the plurality of permanent magnets 22 are inserted and installed in the permanent magnet insertion holes 26 so that the thick portions b thereof are disposed at the center side of the magnetic pole, and the thin portions a thereof are disposed at the edge side of the magnetic pole. The reason why the plurality of permanent magnets 22 are disposed as described above is to form the higher magnetic flux at the center side of the magnetic pole than the edge side thereof and thus to form the gap flux density in the sine curve shape. By forming the gap flux density in the sine curve shape, the cogging torque and the torque ripper of the motor may be reduced, and thus the generation of the vibration and noise may be minimized when the motor is driven.

At this time, the plurality of permanent magnets 22 may be installed to be symmetrical with respect to the rotational shaft insertion hole 25, and may have the trapezoidal shape in section in a vertical direction of the rotational shaft 30. The plurality of permanent magnets 22 have longer lengths at the sides thereof facing the rotational shaft insertion hole 25 than the other sides. That is, the plurality of permanent magnets 22 may respectively have a first side 41, a second side 42, a third side 43 and a fourth side 44. At this time, the first side 41 is opposite to the rotational shaft insertion hole 25. The second side 42 is opposite to the first side 41. The third side 43 connects one ends of the first and second sides 41 and 42, and is shorter than the first and second sides 41 and 42 and is disposed at the center of the magnetic pole. And the fourth side 44 connects the other ends of the first and second sides 41 and 42, and is shorter than the third side 43, and is disposed at the edge of the magnetic pole. At this time, the third and fourth sides 43 and 33 of the plurality of permanent magnets 22 may have a parallel trapezoidal shape.

For example, the plurality of permanent magnets 22 may include a pair of first permanent magnets 28 configured to form the N pole and to be adjacent to each other, and a pair of second permanent magnets 29 configured to form the S pole and to be adjacent to each other. The pair of first permanent magnets 28 and the pair of second permanent magnets 29 are installed at the rotor iron core 21 to be symmetrical with respect to the rotational shaft 30. Of course, the thick portions b of the pair of first permanent magnets 28 are disposed to face each other, and the thin portions a thereof are disposed at an opposite side thereto. The thick portions b of the pair of second permanent magnets 29 are also disposed to face each other, and the thin portions a thereof are disposed at an opposite side thereto. At this time, each angle between the pair of first permanent magnets 28 and between the pair of second permanent magnets 29 may be an obtuse angle, and each angle between the adjacent first and second permanent magnets 28 and 29 may be an acute angle. That is, the angle formed between the pair of first permanent magnets 28 and the angle formed between the pair of second permanent magnets 29 are the obtuse angles, and the angle formed between one of the first permanent magnets 28 and one of the pair of second permanent magnets 29, which are adjacent to each other, is the acute angle.

As illustrated in FIG. 5, two first permanent magnets 28 and two second permanent magnets 29 may be provided. The plurality of first and second permanent magnets 28 and 29 may be inserted and installed in the rotor iron core 21 so that the angle between the pair of first permanent magnets 28 and the angle between the pair of second permanent magnets 29 may be 90 degrees or more, respectively, and the angle between the adjacent first and second permanent magnets 28 and 29 may be 90 degrees or less.

The third embodiment illustrates an example in which the four permanent magnets 22 are disposed around the rotational shaft insertion hole 25, and the pair of first permanent magnets 28 form the N pole, and the pair of second permanent magnets 29 form the S pole, but is not limited thereto. For example, four or more even-numbered permanent magnets 22 may be inserted and installed in the rotor iron core 21, or the plurality of adjacent permanent magnets 22 may be inserted and installed in the rotor iron core 21 to have different magnetic poles.

Meanwhile, the third embodiment illustrates an example in which the third and fourth sides 43 and 44 of each of the permanent magnets have the parallel trapezoidal shape, but is not limited thereto. For example, the third and fourth sides 43 and 44 may not be parallel with each other. Of course, the third side 43 is formed to be thicker than the fourth side 44 (a<b).

And as described above, the rotor iron core 21 has the plurality of conductive bar insertion holes 27 formed around the outside of the plurality of permanent magnet insertion holes 26. Here, the plurality of conductive bar insertion holes 27 may be formed in the same direction as the plurality of permanent magnet insertion holes 26 so as to pass through the rotor iron core 21. The plurality of conductive bar insertion holes 27 have elongated shapes to be disposed at an edge of the rotor iron core 21. The conductive bar insertion holes 27 may be formed in slot shapes toward the permanent magnets 22. For example, the conductive bar insertion holes 27 may have an elongated ellipse shape or an elongated quadrangular shape of which each long side has both ends formed to be convex toward an outside thereof. The plurality of conductive bar insertion holes 27 may be formed in the same shapes. The gaps among the plurality of conductive bar insertion holes 27 may be formed to be wider at the center of the magnetic pole than the edge thereof (d1>d2). The gaps among the plurality of conductive bar insertion holes 27 may be formed to be gradually reduced from the center of the magnetic pole toward the edge thereof.

The plurality of conductive bars 23 are inserted and installed in the plurality of conductive bar insertion holes 27. The plurality of conductive bars 23 may be installed in the plurality of conductive bar insertion holes 27 in a die-casting manner. The conductive bars 23 may be generally formed of an aluminum material (Al) having excellent electrical conductivity and die-casting performance. The conductive bars 23 formed in the die-casting manner are formed to have shapes corresponding to shapes of the conductive bar insertion holes 27. At this time, the gaps among the plurality of conductive bars 23 are formed to be wider at the center of the magnetic pole than the edge thereof.

The reason why the gap d1 between the conductive bars 23 disposed at the center of the magnetic pole provided with the permanent magnet 22 is formed to be wider than the gap d2 between the conductive bars 23 disposed at the edge of the magnetic pole is to focus the gap flux density on the center of the magnetic pole and thus to form the gap flux density in the sine curve shape, as illustrated in FIG. 7. That is, in a typical case, since the plurality of conductive bars are radially installed toward a center of the rotational shaft 30, the gap flux density between the rotor and the stator is formed in a square wave shape, and thus the cogging torque is generated, and the vibration and noise are increased. However, in the case in which the gap d1 between the conductive bars 23 disposed at the center of the magnetic pole is formed to be wider than the gap d2 between the conductive bars 23 disposed at the edge of the magnetic pole, and thus the gap flux density is formed in the sine curve shape, like in the third embodiment, the cogging torque generated when the synchronous motor 100a according to the third embodiment is driven may be reduced, and thus the generation of the vibration and noise may be also reduced when the synchronous motor 100a is driven.

Particularly, since the plurality of conductive bars 23 are inserted and installed in the rotor iron core 21 so that the gaps therebetween are gradually reduced from the center of the magnetic pole toward the edge thereof, and the gap flux density is the highest at the center of the magnetic pole of the permanent magnets 22, and is gradually reduced from the center of the magnetic pole toward the edge thereof, the gap flux density may be formed to be closer to the sine curve.

As described above, in the synchronous motor 100a according to the third embodiment, the rotor 20a is started to be rotated and driven by a torque generated due to an interaction between a secondary current generated by a voltage deserted to the conductive bars 23 of the rotor 20a and a magnetic flux generated by the coil 16 of the stator 10, and when the rotor 20a is operated with a normal speed, the magnetic flux of the permanent magnets 22 installed at the rotor 20a and the magnetic flux generated from the stator 10 are mutually synchronized, and thus the rotor 20a is operated at a speed of a rotating magnetic field of the stator 10.

At this time, when the plurality of permanent magnets 22 are inserted and installed in the rotor iron core 21, the thick portions b thereof are disposed to the center side of the magnetic pole, and the thin portions a thereof are disposed to the edge side of the magnetic pole. Therefore, the gap flux density is formed in the sine curve shape, thereby reducing the cogging torque, minimizing the torque ripple and thus improving the vibration and noise characteristics.

That is, when the permanent magnets 22 are inserted and installed in the rotor iron core 21, the thick portions thereof are disposed to the center side of the magnetic pole, and the thin portions thereof are disposed to the edge side of the magnetic pole, and thus, as illustrated in the wave pattern diagram of FIG. 7, a higher magnetic flux may be generated at the center of the magnetic pole than the edge thereof. Therefore, the gap flux density may be formed in the sine curve shape. At this time, in the wave pattern diagram of FIG. 7, a horizontal axis indicates an angle θ, and a vertical indicates magnetic flux density B.

Further, the gap d1 between the conductive bars 23 disposed at the center of the magnetic pole formed by the permanent magnets 22 is formed to be wider than the gap d2 between the conductive bars 23 disposed at the edge of the magnetic pole, and thus the gap flux density is focused on the center of the magnetic pole and formed in the sine curve shape.

FIG. 8 is a plan view illustrating a rotor 20b of a synchronous motor including permanent magnets 22 having different thicknesses and conductive bars 23 having different gaps according to a fourth embodiment of the present invention. FIG. 9 is a plan view a synchronous motor 100b having the rotor 20b of FIG. 8. And FIG. 10 is a view schematically illustrating gap flux density generated by a structure of the rotor 20b of FIG. 8 and a wave pattern diagram thereof.

Referring to FIGS. 8 to 10, the synchronous motor 100b according to the fourth embodiment of the present invention includes the rotor 20b and a stator 10 in which the rotor 20b is rotatably inserted and installed. The stator 10 has a rotor insertion hole 18 at a center thereof, and a coil 16 is wound around an inner circumferential surface of the rotor insertion hole 18. The rotor 20b is inserted into the rotor insertion hole 18 of the stator 10 and installed to be rotatable.

The stator 10 includes a stator iron core 11 having the rotor insertion hole 18, and the coil 16 wound along the inner circumferential surface of the rotor insertion hole 18 of the stator iron core 11. At this time, an inner diameter of the rotor insertion hole 18 is formed to be larger than an outer diameter of the rotor 20b, and a gap is defined by a difference between the inner diameter of the rotor insertion hole 18 and the outer diameter of the rotor 20b.

The stator iron core 11 is formed by axially stacking a plurality of stator iron plates 12 having the same shapes. The stator iron core 11 has the rotor insertion hole 18 in which the rotor 20b may be inserted and located. The stator iron core 11 has a plurality of teeth 14 formed along an inner circumferential surface thereof to be spaced apart at regular intervals. The plurality of teeth 14 protrude from the inner circumferential surface of the stator iron core 11 toward a central axis of the stator iron core 11 to be close to an outer circumferential surface of the rotor 20b which is inserted and installed in the rotor insertion hole 18. At this time, silicon steel plates may be used for the stator iron plates 12. An inside of a virtual surface formed by distal ends of the teeth 14 of the stator iron core 11 forms the rotor insertion hole 18.

And the coil 16 is wound on each of the plurality of teeth 14, and when an AC power source is applied thereto, a rotational magnetic flux is generated by a structure of the stator 10.

Meanwhile, although not shown, a rotational shaft 30 is rotatably installed via a bearing at a casing or a shell forming a case of the motor 100b.

The rotor 20b is a rotor of the synchronous motor 100b which is inserted into the rotor insertion hole and installed to be rotatable, and includes a rotor iron core 21, and a plurality of permanent magnets 22 and a plurality of conductive bars 23 embedded in the rotor iron core 21. The rotor iron core 21 has a rotational shaft insertion hole 25 at a center thereof, in which a rotational shaft 30 is inserted and installed, and a plurality of permanent magnet insertion holes 26 around the rotational shaft insertion hole 25, and a plurality of conductive bar insertion holes 27 around an outside of the plurality of permanent magnet insertion holes 26. The plurality of permanent magnets 22 are respectively inserted into the permanent magnet insertion holes 26 to form an N pole and an S pole. The plurality of conductive bars 23 are respectively inserted and installed into the plurality of conductive bar insertion holes 27. At this time, the plurality of permanent magnets 22 have different thicknesses according to a distance from a center of the magnetic pole, and thick portions b thereof are disposed to the center side of the magnetic pole, and thin portions a thereof are disposed to the edge side of the magnetic pole. A gap d1 between the conductive bars 23 located at the center of the magnetic pole formed by the plurality of permanent magnets 22 is formed to be wider than a gap d2 between the conductive bars 23 at the edge of the magnetic pole.

As described above, in the rotor 20b according to the fourth embodiment, when the permanent magnets 22 are inserted into the rotor iron core 21, the permanent magnets 22 are inserted and installed so that the thick portions b thereof are disposed at the center side of the magnetic pole, and the thin portions a thereof are disposed at the edge side of the magnetic pole. Therefore, gap flux density is formed in a sine curve shape, thereby reducing a cogging torque, minimizing a torque ripple and thus improving vibration and noise characteristics.

That is, when the permanent magnets 22 are disposed at the rotor iron core 21, the thick portions thereof are disposed at the center side of the magnetic pole, and the thin portions thereof are disposed at the edge side of the magnetic pole (a<b), and thus a higher magnetic flux may be generated at the center of the magnetic pole relative to the edge thereof. Therefore, the gap flux density of the motor having the rotor 20b according to the fourth embodiment is formed in the sine curve shape, and the cogging torque and the torque ripple of the motor may be reduced. In this instance, generation of vibration and noise may be minimized when the motor is driven.

Further, distances L1 of the conductive bars 23 located at the center of the magnetic pole formed by the permanent magnets 22 are formed to be shorter than distances L2 of the conductive bars 23 at the edge of the magnetic pole, such that the gap flux density is focused on the center of the magnetic pole, and thus formed in the sine curve shape. Since the gap flux density is formed in the sine curve shape, the cogging torque generated when the synchronous motor 100b is driven may be reduced, and the generation of vibration and noise may be also minimized when the synchronous motor 100b is driven.

Specifically, the rotor 20b according to the fourth embodiment will be described.

The rotor iron core 21 is formed by axially stacking a plurality of rotor iron plates 24 having the same shapes. The rotational shaft insertion hole 25 in which the rotational shaft 30 is inserted is formed in the center of the rotor iron core 21. The plurality of permanent magnet insertion holes 26 are formed in the rotor iron core 21 around the rotational shaft insertion hole 25. And the rotor iron core 21 has the plurality of conductive bar insertion holes 27 formed around the outer sides of the plurality of permanent magnet insertion holes 26.

At this time, silicon steel plates may be used for the rotor iron plates 24. The rotational shaft insertion hole 25 and the permanent magnet insertion holes 26 may be formed to be vertical with respect to an upper surface of the rotor iron core 21.

The fourth embodiment illustrates an example in which four permanent magnet insertion holes 26 in which the permanent magnets 22 are installed so as to have a quadrangular shape in section with respect to an axial direction of the rotational shaft insertion holes 25 around the rotational shaft insertion hole 25 are formed in the rotor iron core 21, but is not limited thereto. For example, the permanent magnet insertion holes 26 may have a trapezoidal shape in section with respect to the axial direction of the rotational shaft insertion holes 25.

And the plurality of permanent magnets 22 are inserted and installed in the plurality of permanent magnet insertion holes 26 of the rotor iron core 21. At this time, the plurality of permanent magnets 22 generate a torque by an interaction with a magnetic flux generated from a coil. Rare earth magnets may be used for the permanent magnets 22.

Particularly, in order to solve imbalance of the gap flux density, the plurality of permanent magnets 22 are inserted and installed in the permanent magnet insertion holes 26 so that the thick portions b thereof are disposed at the center side of the magnetic pole, and the thin portions a thereof are disposed at the edge side of the magnetic pole. The reason why the plurality of permanent magnets 22 are disposed as described above is to form the higher magnetic flux at the center side of the magnetic pole than the edge side thereof and thus to form the gap flux density in the sine curve shape. By forming the gap flux density in the sine curve shape, the cogging torque and the torque ripper of the motor may be reduced, and thus the generation of the vibration and noise may be minimized when the motor is driven.

At this time, the plurality of permanent magnets 22 may be installed to be symmetrical with respect to the rotational shaft insertion hole 25, and may have the trapezoidal shape in section in a vertical direction of the rotational shaft 30. The plurality of permanent magnets 22 have longer lengths at the sides thereof facing the rotational shaft insertion hole 25 relative to the other sides. That is, the plurality of permanent magnets 22 may respectively have a first side 41, a second side 42, a third side 43 and a fourth side 44. At this time, the first side 41 is opposite to the rotational shaft insertion hole 25. The second side 42 is opposite to the first side 41. The third side 43 connects one ends of the first and second sides 41 and 42, and is shorter than the first and second sides 41 and 42 and is disposed at the center of the magnetic pole. And the fourth side 44 connects the other ends of the first and second sides 41 and 42, and is shorter than the third side 43, and is disposed at the edge of the magnetic pole. At this time, the third and fourth sides 43 and 33 of the plurality of permanent magnets 22 may have a parallel trapezoidal shape.

For example, the plurality of permanent magnets 22 may include a pair of first permanent magnets 28 configured to form the N pole and to be adjacent to each other, and a pair of second permanent magnets 29 configured to form the S pole and to be adjacent to each other. The pair of first permanent magnets 28 and the pair of second permanent magnets 29 are installed at the rotor iron core 21 to be symmetrical with respect to the rotational shaft 30. Of course, the thick portions b of the pair of first permanent magnets 28 are disposed to face each other, and the thin portions a thereof are disposed at an opposite side thereto. The thick portions b of the pair of second permanent magnets 29 are also disposed to face each other, and the thin portions a thereof are disposed at an opposite side thereto. At this time, each angle between the pair of first permanent magnets 28 and between the pair of second permanent magnets 29 may be an obtuse angle, and each angle between the adjacent first and second permanent magnets 28 and 29 may be an acute angle. That is, the angle formed between the pair of first permanent magnets 28 and the angle formed between the pair of second permanent magnets 29 are the obtuse angles, and the angle formed between one of the first permanent magnets 28 and one of the pair of second permanent magnets 29, which are adjacent to each other, is the acute angle.

As illustrated in FIG. 8, two first permanent magnets 28 and two second permanent magnets 29 may be provided. The plurality of first and second permanent magnets 28 and 29 may be inserted and installed in the rotor iron core 21 so that the angle between the pair of first permanent magnets 28 and the angle between the pair of second permanent magnets 29 may be 90 degrees or more, respectively, and the angle between the adjacent first and second permanent magnets 28 and 29 may be 90 degrees or less.

The fourth embodiment illustrates a case in which the four permanent magnets 22 are disposed around the rotational shaft insertion hole 25, and the pair of first permanent magnets 28 form the N pole, and the pair of second permanent magnets 29 form the S pole, but is not limited thereto. For example, four or more even-numbered permanent magnets 22 may be inserted and installed in the rotor iron core 21, or the plurality of adjacent permanent magnets 22 may be inserted and installed in the rotor iron core 21 to have different magnetic poles.

Meanwhile, the fourth embodiment illustrates that the third and fourth sides 43 and 44 of each of the permanent magnets have the parallel trapezoidal shape, but is not limited thereto. For example, the third and fourth sides 43 and 44 may not be parallel with each other. Of course, the third side 43 is formed to be thicker than the fourth side 44 (a<b).

And as described above, the rotor iron core 21 has the plurality of conductive bar insertion holes 27 formed around the outer sides of the plurality of permanent magnet insertion holes 26. Here, the plurality of conductive bar insertion holes 27 may be formed in the same direction as the plurality of permanent magnet insertion holes 26 so as to pass through the rotor iron core 21. The plurality of conductive bar insertion holes 27 have elongated shapes to be disposed at an edge of the rotor iron core 21. The conductive bar insertion holes 27 may be formed in slot shapes toward the permanent magnets 22. For example, the conductive bar insertion holes 27 may have an elongated ellipse shape or an elongated quadrangular shape of which each long side has both ends formed to be convex toward an outside thereof. The plurality of conductive bar insertion holes 27 may be formed to be spaced apart from each other at regular intervals. The lengths of the plurality of conductive bar insertion holes 27 may be formed to be shorter at the center of the magnetic pole than the edge thereof (L1>L2). The lengths of the plurality of conductive bar insertion holes 27 may be formed to be gradually shorter from the center of the magnetic pole toward the edge thereof.

Further, The plurality of conductive bars 23 are inserted and installed in the plurality of conductive bar insertion holes 27. The plurality of conductive bars 23 may be formed to have constant gaps among the plurality of conductive bars 23. The plurality of conductive bars 23 may be installed in the plurality of conductive bar insertion holes 27 in a die-casting manner. The conductive bars 23 may be generally formed of an aluminum material (Al) having excellent electrical conductivity and die-casting performance. The conductive bars 23 formed in the die-casting manner are formed to have shapes corresponding to shapes of the conductive bar insertion holes 27. At this time, the distances of the plurality of conductive bars 23 are formed to be shorter at the center of the magnetic pole than the edge thereof. By forming the plurality of conductive bars 23 as described above, the distances of the permanent magnets 22 forming the magnetic poles and the conductive bars 23 are formed to be longer at the center of the magnetic pole than the edge thereof.

The reason why the lengths L1 of the conductive bars 23 disposed at the center of the magnetic pole formed by the permanent magnet 22 are formed to be shorter than the lengths L2 of the conductive bars 23 disposed at the edge of the magnetic pole is to focus the gap flux density on the center of the magnetic pole and thus to form the gap flux density in the sine curve shape, as illustrated in FIG. 10. That is, in a typical case, since the plurality of conductive bars are radially installed toward a center of the rotational shaft 30, the gap flux density between the rotor and the stator is formed in a square wave shape, and thus the cogging torque is generated, and the vibration and noise are increased. However, in the case in which the lengths L1 of the conductive bar 23 disposed at the center of the magnetic pole are formed to be shorter than the lengths L2 of the conductive bars 23 disposed at the edge of the magnetic pole, and thus the gap flux density is formed in the sine curve shape, like in the fourth embodiment, the cogging torque generated when the synchronous motor 100b according to the fourth embodiment is driven may be reduced, and thus the generation of the vibration and noise may be also reduced when the synchronous motor 100b is driven.

Particularly, since the plurality of conductive bars 23 are inserted and installed in the rotor iron core 21 so that the lengths of the plurality of conductive bars 23 are gradually shorter from the center of the magnetic pole toward the edge thereof, and the gap flux density is the highest at the center of the magnetic pole of the permanent magnets 22, and is gradually reduced from the center of the magnetic pole toward the edge thereof, the gap flux density may be formed to be closer to the sine curve.

As described above, in the synchronous motor 100b according to the fourth embodiment, the rotor 20b is started to be rotated and driven by a torque generated due to an interaction between a secondary current generated by a voltage deserted to the conductive bars 23 of the rotor 20b and a magnetic flux generated by the coil 16 of the stator 10, and when the rotor 20b is operated with a normal speed, the magnetic flux of the permanent magnets 22 installed at the rotor 20b and the magnetic flux generated from the stator 10 are mutually synchronized, and thus the rotor 20b is operated at a speed of a rotating magnetic field of the stator 10.

At this time, when the plurality of permanent magnets 22 are inserted and installed in the rotor iron core 21, the thick portions b thereof are disposed to the center side of the magnetic pole, and the thin portions a thereof are disposed to the edge side of the magnetic pole. Therefore, the gap flux density is formed in the sine curve shape, thereby reducing the cogging torque, minimizing the torque ripple and thus improving the vibration and noise characteristics.

That is, when the permanent magnets 22 are inserted and installed in the rotor iron core 21, the thick portions thereof are disposed to the center side of the magnetic pole, and the thin portions thereof are disposed to the edge side of the magnetic pole, and thus, as illustrated in the wave pattern diagram of FIG. 10, a higher magnetic flux may be generated at the center of the magnetic pole than the edge thereof. Therefore, the gap flux density may be formed in the sine curve shape. At this time, in the wave pattern diagram of FIG. 10, a horizontal axis indicates an angle θ, and a vertical indicates magnetic flux density B. Referring to FIG. 10, it may be confirmed that the gap flux density is formed in the sine curve shape by inserting and installing the permanent magnets having different thicknesses in the rotor 20b.

Further, the lengths L1 of the conductive bars 23 disposed at the center of the magnetic pole formed by the permanent magnets 22 are formed to be shorter than the lengths L2 of the conductive bars 23 disposed at the edge of the magnetic pole, and thus the gap flux density is focused on the center of the magnetic pole and formed in the sine curve shape.

Meanwhile, the fourth embodiment illustrates an example in which the gaps among the plurality of conductive bars 23 are formed to be constant, but is not limited thereto. That is, as illustrated in FIG. 11, the gap d1 between the conductive bars 23 disposed at the center of the magnetic pole formed by the plurality of the permanent magnets 22 may be formed to be wider than the gap d2 between the conductive bars 23 disposed at the edge of the magnetic pole.

FIG. 11 is a plan view illustrating a rotor 120b of a synchronous motor according to a fifth embodiment of the present invention.

Referring to FIG. 11, the rotor 120b according to the fifth embodiment of the present invention has the same structure as that of the rotor 20b (FIG. 8) according to the fourth embodiment, except that the gap d1 between the conductive bars 23 disposed at the center of the magnetic pole formed by the plurality of the permanent magnets 22 is formed to be wider than the gap d2 between the conductive bars 23 disposed at the edge of the magnetic pole, and thus a structure in which the plurality of conductive bars 23 are installed in the rotor iron core 21 will be mainly described.

Here, the plurality of conductive bars 23 are inserted and installed in the plurality of conductive bar insertion hole 27. Gaps among the plurality of conductive bars 23 are formed to be wider at the center of the magnetic pole than the edge thereof by the above-mentioned plurality of conductive bar insertion holes 27.

As described above, the reason why the gap d1 between the conductive bars 23 disposed at the center of the magnetic pole formed by the permanent magnets 22 is formed to be wider than the gap d2 between the conductive bars 23 disposed at the edge of the magnetic pole is to focus the gap flux density on the center of the magnetic pole and thus to form the gap flux density in the sine curve shape. Like in the second embodiment, lengths of the conductive bars 23 disposed at the center of the magnetic pole formed by the permanent magnets 22 are formed to be shorter than lengths of the conductive bars 23 disposed at the edge of the magnetic pole, the gap d1 between the conductive bars 23 disposed at the center of the magnetic pole is formed to be wider than the gap d2 between the conductive bars 23 disposed at the edge of the magnetic pole, and thus the gap flux density may be formed to be closer to the sine wave shape. Therefore, the cogging torque generated when the synchronous motor according to the second embodiment is driven may be reduced, and thus the generation of the vibration and noise may be also reduced when the synchronous motor is driven.

Particularly, since the plurality of conductive bars 23 are inserted and installed in the rotor iron core 21 so that the gaps therebetween are gradually reduced from the center of the magnetic pole toward the edge thereof, and the gap flux density is the highest at the center of the magnetic pole formed by the permanent magnets 22, and is gradually reduced from the center of the magnetic pole toward the edge thereof, the gap flux density may be formed to be closer to the sine curve.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A rotor of a motor, which comprises permanent magnets having different thicknesses and is rotatably inserted and installed into a rotor insertion hole of a stator, comprising;
a rotor iron core configured to have a rotational shaft insertion hole, in which a rotational shaft is inserted, at a center thereof, and also have a plurality of permanent magnet insertion holes around the rotational shaft insertion hole; and
a plurality of permanent magnets inserted into the plurality of permanent magnet insertion holes to form an N pole and an S pole,
wherein the plurality of permanent magnets have different thicknesses according to distances from centers of the magnetic poles, and thick portions of the plurality of permanent magnets are disposed at the center of the magnetic pole and thin portions thereof are disposed at an edge of the magnetic pole.

2. The rotor claim 1, wherein the plurality of permanent magnets are installed to be symmetrical centering on the rotational shaft insertion hole, a section in a vertical direction with respect to the rotational shaft has a trapezoidal shape, and sides thereof facing the rotational shaft insertion hole are longer in length than other sides thereof adjacent to the sides facing the rotational shaft insertion hole.

3. The rotor of claim 1, wherein each of the plurality of permanent magnets comprises a first side facing the rotational shaft insertion hole, a second side facing the first side, a third side configured to connect one ends of the first and second sides and to be shorter than the first and second sides and to be disposed at a center portion of the magnetic pole, and a fourth side configured to connect the other ends of the first and second sides and to be shorter than the third side and to be disposed at an edge portion of the magnetic pole.

4. The rotor of claim 2, wherein the plurality of permanent magnets comprises one pair of first permanent magnets configured to form the N pole and to be adjacent to each other; and one pair of second permanent magnets configured to form the S pole and to be adjacent to each other, and
the thick portions of the one pair of first permanent magnets are disposed to face each other, and the thin portions thereof are disposed at opposite sides thereto, and
the thick portions of the one pair of second permanent magnets are disposed to face each other, and the thin portions thereof are disposed at opposite sides thereto.

5. The rotor of claim 4, wherein an angle between the one pair of first permanent magnets and an angle between the one pair of second permanent magnets are obtuse angles, and an angle between one of the first permanent angles and one of the second permanent angles, which are adjacent to each other, is an acute angle.

6. The rotor of claim 1, wherein the rotor iron core has a plurality of conductive bar insertion holes formed around outer sides of the plurality of permanent magnet insertion holes, and the rotor further comprises a plurality of conductive bars inserted and installed in the plurality of conductive bar insertion holes.

7. The rotor of claim 6, wherein gaps among the plurality of conductive bars are constant.

8. The rotor of claim 1, wherein the plurality of permanent magnets are disposed so that a gap between the conductive bars disposed at the center of the magnetic pole formed by the plurality of permanent magnets is formed to be wider than a gap between the conductive bars disposed at the edge of the magnetic pole.

9. The rotor of claim 8, wherein the gaps among the plurality of conductive bars are formed to be gradually reduced from the center of the magnetic pole toward the edge thereof.

10. The rotor of claim 8, wherein a gap between the conductive bar insertion holes disposed at the center of the magnetic pole formed by the plurality of permanent magnets is formed to be wider than a gap between the conductive bar insertion holes disposed at the edge of the magnetic pole.

11. The rotor of claim 1, wherein the plurality of permanent magnets are disposed so that lengths of the conductive bars disposed at the center of the magnetic pole formed by the plurality of permanent magnets are formed to be shorter than lengths of the conductive bars disposed at the edge of the magnetic pole.

12. A motor which comprises permanent magnets having different thicknesses, comprising;
a rotor; and
a stator configured to have a rotor insertion hole, in which the rotor is inserted, at a center thereof and to comprise a coil wound around an inner circumferential surface of the rotor insertion hole,
wherein the rotor comprises a rotor iron core configured to have a rotational shaft insertion hole, in which a rotational shaft is inserted, at a center thereof, and also have a plurality of permanent magnet insertion holes around the rotational shaft insertion hole, and a plurality of permanent magnets inserted into the plurality of permanent magnet insertion holes to form an N pole and an S pole, and the plurality of permanent magnets have different thicknesses according to distances from centers of the magnetic poles, and thick portions of the plurality of permanent magnets are disposed at the center of the magnetic pole and thin portions thereof are disposed at an edge of the magnetic pole.

13. The motor of claim 12, wherein a gap between the conductive bars disposed at the center of the magnetic pole formed by the plurality of permanent magnets is formed to be wider than a gap between the conductive bars disposed at the edge of the magnetic pole.

14. The motor of claim 12, wherein lengths of the conductive bars disposed at the center of the magnetic pole formed by the plurality of permanent magnets are formed to be shorter than lengths of the conductive bars disposed at the edge of the magnetic pole.
